(19) United States
(12) Patent Application Publication
(10) Pub. No.: US 2015/0276202 A1
(43) Pub. Date: Oct. 1, 2015

(54) RIDER PROTECTOR SAFETY VEST

(71) Applicant: Stephen Haslem, SR., Los Angeles, CA (US)

(72) Inventor: Stephen Haslem, SR., Los Angeles, CA (US)

(21) Appl. No.: 14/668,922

(22) Filed: Mar. 25, 2015

Related U.S. Application Data
(60) Provisional application No. 61/970,239, filed on Mar. 25, 2014.

(51) Int. Cl. F21V 33/00; G08B 5/36; A41D 13/01; F21L 4/08

(52) U.S. Cl. CPC F21V 33/0008; F21L 4/08; G08B 5/36; A41D 13/01; F21W 2111/10

(57) ABSTRACT

A high visibility electronic safety vest for use by a motorcycle or bicycle rider, comprising a vest equipped with running lights, brake lights and turn signals that are easily visible to following motorists, wherein the lights are battery powered Light Emitting Diode or LED running lights, brake lights, and turn signals.

### CLAIM OF PRIORITY

This patent application claims priority under 35 USC 119 (e) (1) from U.S. Provisional Patent Application Ser. No. 61/970,239 filed Mar. 25, 2014, of common inventorship herewith entitled, “Rider Protector,” which is incorporated herein by reference as though the same were set forth in its entirety.

### FIELD OF THE INVENTION

The present invention pertains to the field of motorcycle accessories, and more specifically to the field of safety attire for motorcyclists.

### BACKGROUND OF THE INVENTION

The prior art has put forth several designs for safety attire for motorcyclists. Among these are:

U.S. Pat. No. 6,558,016 to Edward C. Restauro describes a motorcyclist garment with illuminated traffic signals for providing better and more visible rear lighting for motorcyclists. The motorcyclist garment with illuminated traffic signals includes a garment having a back side, a neck opening, and arm openings. This garment includes a light emitting assembly with light emitting members disposed in the back side of said garment. Wires and a power cord are connected to the light emitting members. A connector plug is attached to an end of the power cord and is adapted to plug into a power jack of a motorcycle.

US Patent 2007/0063831 to Barry Perkins and Joseph Cordina describes a signaling system for a motorcycle or bicycle providing a light indication to other motorists. An indication mechanism is attached to a garment of the rider. The indication mechanism has at least two banks of LEDs arrays and a wireless radio receiver. A signal interface is linked to the wiring system of the motorcycle light system. The signal interface intercepts signals transmitted on the wiring system of the motorcycle light system. The system also includes a wireless radio transmitter in communication with the signal interface. When the signal interface detects a signal sent through the wiring system of the motorcycle, the signal interface sends a signal via the transmitter to the receiver of the indication mechanism. The indication mechanism then illuminates the appropriate bank of LED arrays to provide a light indication to warn other motorists. In an alternate embodiment of the present invention, the indication mechanism is worn by a cyclist. The signal interface may communicate with a sensing device which receives signals from a braking mechanism of the bicycle. When the braking mechanism is actuated, the sensing device senses the braking action and sends a signal via the transmitter to the receiver of the indication mechanism, which in turn illuminates the LED arrays. Alternately, rather than utilizing a signal interface, the indication mechanism includes an accelerometer to detect deceleration of the bicycle.

U.S. Pat. No. 6,538,567 to Robin H. Stewart describes a motorcycle jacket which has turn signal lights attached to the back of the jacket in the upper left and right shoulder areas. The lights are electrically connected to the motorcycle electrical system, so that when the motorcycle turn signals are actuated, the jacket turn signals will flash in synchronism with them.

None of these prior art references describe the present invention.

### SUMMARY OF THE INVENTION

It is an object of the present invention to provide a high visibility electronic safety vest that is worn by motorcyclists and bicyclists.

### BRIEF DESCRIPTION OF THE DRAWINGS

FIG. 1 is an illustrative prototypical back view showing two sets of red Light Emitting Diode or LED running lights, red LED brake lights, a hard plastic shield, a right signal LED light, a left signal LED light, and a plug in for recharging.

FIG. 2 is a prototypical functional back view showing a solar cell for recharging and a wireless remote.

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Riding bicycles and motorcycles are activities enjoyed by many riders, but are dangerous because they involve sharing roads with motor vehicles. Highway safety statistics show that, per mile driven, motorcyclists are approximately thirty two times more likely than automobile drivers to be involved in an accident, approximately sixteen times more likely to die in a motor vehicle traffic crash, and approximately four times more likely to be injured.

The present invention, hereafter referred to as the Rider

Protector Safety Vest, or Rider Protector, is a high visibility electronic safety vest for motorcyclists and bicyclists. Equipped with running lights, brake lights and turn signals that are easily visible to following motorists, the Rider Protector vest dramatically enhances the visibility and safety of cyclists. The back of the vest incorporates battery powered Light Emitting Diode or LED running lights, brake lights, and turn signals.

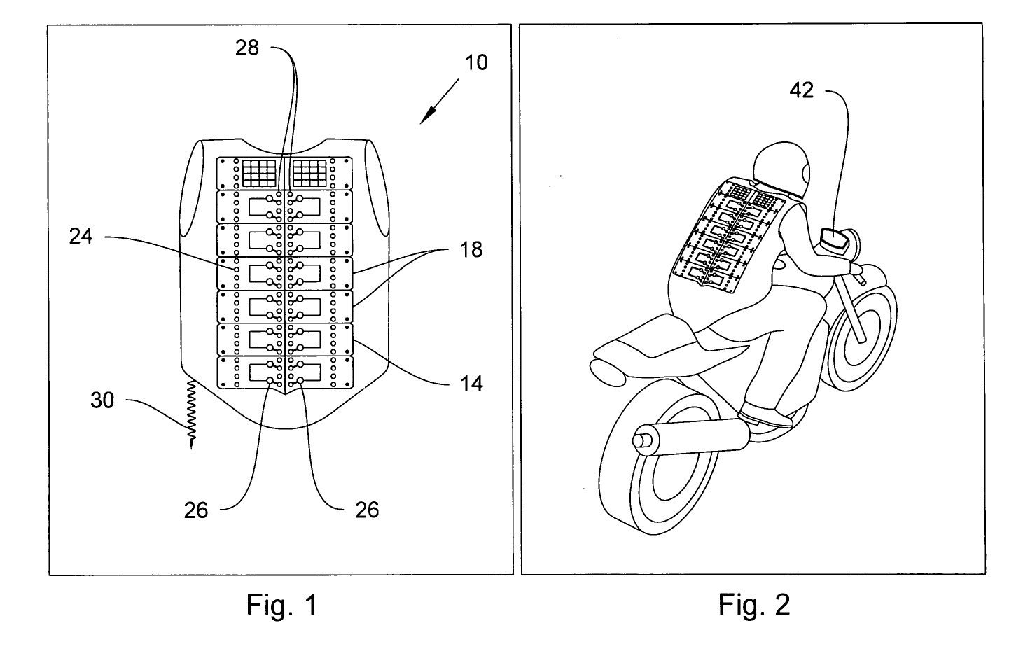

Please refer to the Figures. The Rider Protector comprises a tough, durable and lightweight vest fabricated in woven nylon with strategically placed foam padding and an exterior shell of Kevlar™. The vest 10 measures approximately twenty and one half inches in height, fourteen and one half inches in width and one quarter inch in thickness or depth. The back of the vest comprises an adjustable fit hard plastic shell 14. This shell is articulated in approximately seven interconnected horizontally oriented panels 18 in which the battery powered LEDs are arranged in vertically oriented columns down the rider's back. The LEDs are arranged in pairs, equidistant on each side from the rider's spine or midpoint. Consisting of a pair of red running lights 24, a pair of flashing yellow turn signals 26, and a pair of bright red brake lights 28, the LED lights are arranged respectively towards the center of the vest on each side. The battery or battery pack necessary to power these lights is incorporated into a panel within the vest or a plug in power pack to be incorporated into the vest. Plug 30 for re-charging can be located in any convenient location, but is shown in FIG. 1 near the bottom of the vest 10. The LED Lights are activated by a set of manual switches via wireless remote 42, or wired into a motorcycle's existing electrical system with a detachable plug 30 in connection. Alternatively, The lights are activated automatically when a rider's activates a headlight, turn signals or brakes.

The Rider Protector essentially transforms a rider's back into a piece of vital safety equipment with its display of running lights, turn signals and brake lights that are far larger and more immediately visible than the safety lights of a motorcycle and conventional hand signals which bicyclists employ. Battery powered, easily worn and adjustable to fit virtually any rider or cyclist, the Rider Protector's vest is highly functional and affordable. Solar cells can be included into the top of the vest, if desired.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A high visibility electronic safety vest for use by a motorcycle or bicycle rider, comprising: a vest equipped with running lights, brake lights and turn signals that are easily visible to following motorists, wherein the lights are battery powered Light Emitting Diode or LED running lights, brake lights, and turn signals.

2. The electronic safety vet of claim 1 wherein the vest comprises a tough, durable and lightweight vest fabricated in woven nylon with strategically placed foam padding and an exterior shell of Kevlar™.

3. The electronic safety vest of claim 1 wherein the vest measures approximately twenty and one half inches in height, fourteen and one half inches in width and one quarter inch in thickness or depth.

4. The electronic safety vest of claim 2, wherein the vest has a back, and the back of the vest comprises an adjustable fit hard plastic shell.

5. The electronic safety vest of claim 4 wherein the shell is articulated in approximately seven interconnected horizontally oriented panels in which the battery powered LEDs are arranged in vertically oriented columns down a rider's back.

6. The electronic safety vest of claim 5, wherein the LEDs are arranged in pairs, and each pair is equidistant on each side from the rider's spine or midpoint.

7. The electronic safety vest of claim 5, wherein the LED's comprise of a pair of red running lights, a pair of flashing yellow turn signals, and a pair of bright red brake lights, wherein the LED light pairs are arranged respectively towards the center of the vest on each side.

8. The electronic safety vest of claim 6, wherein the LED's comprise of a pair of red running lights, a pair of flashing yellow turn signals, and a pair of bright red brake lights, wherein the LED light pairs are arranged respectively towards the center of the vest on each side.

9. The electronic safety vest of claim 1, wherein the battery or battery pack necessary to power the LED lights is incorporated into a panel within the vest or a plug in power pack to be incorporated into the vest.

10. The electronic safety vest of claim 7, wherein the battery or battery pack necessary to power the LED lights is incorporated into a panel within the vest or a plug in power pack to be incorporated into the vest.

11. The electronic safety vest of claim 7, wherein the LED lights are activated by a set of manual switches by wireless remote or wired into a motorcycle's existing electrical system with a detachable plug in connection.

12. The electronic safety vest of claim 7 wherein the LED lights are activated automatically when a rider's activates a headlight, turn signals or brakes.

13. The electronic safety vest of claim 1, wherein the battery or battery pack necessary to power the LED lights is incorporated into a panel within the vest or a plug in power pack to be incorporated into the vest.

14. The electronic safety vest of claim 1, wherein the LED lights are activated by a set of manual switches by wireless remote or wired into a motorcycle's existing electrical system with a detachable plug in connection.

15. The electronic safety vest of claim 1 wherein the LED lights are activated automatically when a rider's activates a headlight, turn signals or brakes.

16. The electronic safety vest of claim 7, further comprising solar cells mounted to the vest.
